(19) United States
(12) Patent Application Publication
(10) Pub. No.: US 2026/0225922 A1
(43) Pub. Date: Aug. 6, 2026

(54) SYSTEMS AND METHODS OF HIGH-PRESSURE NANOFILTRATION TO REDUCE MAGNESIUM CONCENTRATION WHILE INCREASING LITHIUM CONCENTRATION IN HIGHLY SALINE BRINES BEFORE DIRECT LITHIUM EXTRACTION

(71) Applicant: Fluid Technology Solutions (FTS), Inc., Albany, OR (US)

(72) Inventors: John R. Herron, Corvallis, OR (US); Edward Beaudry, Albany, OR (US)

(21) Appl. No.: 19/159,086

(22) PCT Filed: Feb. 26, 2024
(86) PCT No.: PCT/US2024/017300

§ 371 Date: Aug. 22, 2025

Related U.S. Application Data
(60) Provisional application No. 63/487,179, filed on Feb. 27, 2023.

(51) Int. Cl. C02F 1/44; B01D 61/02; C02F 101/10; C02F 103/10; C22B 3/22; C22B 11/00; C22B 26/10; C22B 26/12

(52) U.S. Cl. CPC C02F 1/442; B01D 61/0271; C22B 3/22; C22B 11/04; C22B 26/10; C22B 26/12; C02F 2101/10; C02F 2103/10; C02F 2301/08

(57) ABSTRACT

Systems and methods for processing a highly saline brine containing monovalent and multivalent cations is disclosed. The systems and methods may include feeding the saline brine into a nanofiltration membrane at a high pressure effective produce a permeate having (1) a concentration of multivalent cations that is lower than saline brine and (2) a concentration of monovalent cations that is higher than the saline brine.

### CROSS-REFERENCE TO RELATED APPLICATIONS

This application claims priority to U.S. Provisional Patent Application No. 63/487,179 filed on Feb. 27, 2023, the disclosure of which is incorporated herein, in its entirety, by this reference.

### BACKGROUND

The demand for lithium has increased rapidly recently, outpacing the supply from existing suppliers. Rapidly increasing prices, government mandates, and supply chain concerns have made domestic production of lithium in the US to be attractive.

At the same time, the fracking revolution in oil and gas production in the US has led to a sharp increase of highly saline produced water (often greater than 180,000 mg/L TDS) as a waste byproduct from the extraction process. This oil and gas produced brine is typically reused for fracking or transported at considerable expense to reinjection wells where it is pumped into rock formations far underground. These brines often contain lithium at concentrations of about 100 to 300 ppm which has a great potential value if it could be separated from the brine. In Pennsylvania alone, where many of the most saline produced waters from the oil and gas extraction process occur, 2.6 billion gallons of produced brine from oil and gas wells were collected in 2022 (Pennsylvania Department of Environmental Protection). The potential value of the lithium in this brine is in the hundreds of millions of dollars.

Lithium concentrations in oil and gas produced water are low enough that the evaporative techniques used to separate lithium in the high-grade South American brine mines are not practical since the mass ratio of lithium to other cations is so small that most of the lithium would be lost to co-precipitation in other salts during the evaporative concentration. Fortunately, several ion-exchange, lithium absorption, and solvent extraction technologies for direct lithium extraction (DLE) from brines are being commercialized. These systems bind the lithium from the brine where it can later be released in much higher concentrations. In most techniques, the elution stream from the DLE is further concentrated to above 10 g/L lithium and the lithium is precipitated as Li₂CO₃.

One of the cations in the produced brine which causes the greatest difficulty in recovering lithium by DLE is magnesium. Because of their similar ionic radius, most DLE techniques sequester a portion of the Mg⁺⁺ ion along with the Lit ion in the feed solution and if the level of Mg is high it can swamp the DLE absorption sites. The Mg can also interfere with the regeneration of the DLE.

Because the capital cost of DLE is lower when the lithium concentration is higher, there is also interest in increasing the concentration of lithium before the brine is introduced to the DLE process. Even an incremental increase in lithium concentration has a positive impact on lithium recovery and equipment cost. It would be most preferable if lithium concentration and magnesium reduction were performed in the same low-cost process or sequential or near-sequential low-cost processes before the brine is introduced to the DLE process.

### BRIEF DESCRIPTION OF THE DRAWINGS

The drawings illustrate several embodiments of the present disclosure, wherein identical reference numerals refer to identical or similar elements or features in different views or embodiments shown in the drawings.

FIG. 1 is a block diagram of a system of high pressure nanofiltration configured to reduce magnesium concentration while increasing lithium concentration in highly saline brine, according to an embodiment.

FIG. 2 is a block diagram of a system of multiple pass high pressure nanofiltration stages configured to reduce magnesium concentration while increasing lithium concentration in highly saline brine, according to an embodiment.

### DETAILED DESCRIPTION

Described herein are devices, systems, and methods using high-pressure nanofiltration to, simultaneously or near simultaneously, reduce magnesium while concentrating lithium from high salinity brines containing high concentrations of multivalent cations, such as calcium and/or magnesium ions and high levels of chloride ions. Under high applied pressures, a brine flux through the membrane occurs. However, calcium and magnesium are substantially blocked from passing. Chlorides pass freely but to maintain electrical neutrality they carry monovalent cations with them. Due to the high level of chloride ions passing through the membrane, this can lead to the concentration of lithium and other monovalent cations being higher on the permeate side than the feed side.

This is novel compared to other pressure driven nanofiltration brine separation systems where the concentration of monovalent cations is higher on the feed side than on the retentate side. Being able to achieve higher concentration of monovalent cations in the permeate results from the high level of divalent cations in the feed, the monovalent anions being predominantly chloride ions, and the high applied pressure. With high concentrations of multivalent cations in the high-pressure nanofiltration feed, the concentration of monovalent cations in the permeate increases relative to the feed even though the total dissolved solids (TDS) in the permeate is lower than in the feed.

It is well known that nanofiltration membranes have much higher rejection of divalent cations as compared to monovalent cations. Nanofiltration of water is usually performed at pressures less than 40 bar with the intention of reducing divalent or multivalent ions such as Mg⁺⁺, Ca⁺⁺, Sr⁺⁺ and SO₄⁻⁻ in the permeate while allowing the passage of monovalent ions such as Na⁺, K⁺, Li⁺ and Cl⁻.

Standard nanofiltration using pressures around 40 bar or below is of limited use in reducing divalent ions in high salinity brine containing high concentrations of calcium and/or magnesium. Due to the high combined osmotic pressure from salts, such as calcium chloride and magnesium chloride, in the feed, pressures above standard nanofiltration pressures need to be applied to keep water flowing through the membrane.

An example of the ions in produced water (brine) from Pennsylvania is shown in Table 1:

TABLE 1
Ionic content of produced water from a Pennsylvania gas well

| | Ca | Mg | K | Na | Li | Cl |
|---|---|---|---|---|---|---|
| mg/L | 19400 | 1420 | 2190 | 58600 | 95.4 | 132000 |

The osmotic pressure of this brine is over 200 bar which is far higher than the pressure which can be applied in a membrane system.

High pressure nanofiltration with pressure around or above 60 bar relies on salt passage through the membrane for water flux to occur. As salt diffuses through the membrane, water will pass with it so that the osmotic pressure of the permeate will be equal to the osmotic pressure of the feed minus the applied pressure. If, for example, the osmotic pressure of the feed is around 200 bar and 70 bar is the applied pressure, the osmotic pressure of the permeate is around 130 bar.

The composition of salts in the permeate will differ from that in the feed because different ions have different diffusion rates through the membrane. The permeability rates through high pressure, thin-film composite (TFC) nanofiltration membranes for the species are in order of descending permeation rates:

$$Monovalent cations ( {Na}^{+} , {K}^{+} , {Li}^{+} ) > {Cl}^{-} > {Ca}^{++} > {Mg}^{++}$$

The ratio of monovalent cations to divalent cations will therefore be higher in the permeate than in the feed.

The actual permeation rate of ions through the membrane is complicated by the requirements of electrical neutrality. Electrically, the cations and anions must remain balanced on both sides of the membrane. The composition of species permeating the membrane is then determined by:
Slow permeation of Ca⁺⁺ and Mg⁺⁺
Faster permeation of Cl⁻ than Ca⁺⁺ and Mg⁺⁺
Na⁺, K⁺ and Li⁺ permeation in quantities needed to electrically balance the Cl⁻
Water passage across the membrane in the quantity which results in the osmotic pressure difference between the feed and permeate to be close to that of the applied pressure.

In brine with high divalent cation and high chloride concentrations, the higher rate of diffusion of Cl-compared to Ca⁺⁺ and Mg⁺⁺ pulls monovalent cations with it to maintain electrical neutrality while divalent cations are concentrated on the retentate side of the nanofiltration membrane. This causes lithium concentrations to be higher in the permeate than in the feed even though the overall salt concentration is lower in the permeate than in the feed.

### Results

The reduction of divalent cations and increase of monovalent cations in the permeate was demonstrated by processing the gas well water in Tables 1 and 2. A 60 L sample of water was processed with a single high-pressure nanofiltration element by pumping the feed through the element at 68 bar and returning the feed reject to the feed tank. Grab samples of feed and permeate were taken during the process at 25% reduction (15 liters) and at 50% reduction (30 liters). Cation concentrations were measured in the feed and permeate by atomic absorption.

TABLE 2
Cation ppm in the initial feed and the feed and permeate
at 25% and 50% reduction.

| | Initial | Feed | Permeate | Feed | Permeate |
|---|---|---|---|---|---|
| | Feed | 25% | 25% | 50% | 50% |
| Sodium | 58600 | 56400 | 67200 | 75200 | 109000 |
| Lithium | 95.4 | 91.2 | 108 | 109 | 172 |
| Magnesium | 1420 | 1910 | 154 | 3470 | 357 |
| Calcium | 19400 | 23800 | 7760 | 39000 | 17300 |
| Potassium | 2190 | 2170 | 2330 | 2720 | 3790 |

It can be seen at 25% and 50% volume reductions, the concentration of monovalent cations is higher in the permeate than in the feed. That is, at 25% reduction the lithium concentration in the feed is 91.2 ppm and the concentration in the permeate is 108 ppm. At 50% reduction, the feed is 109 and the permeate is 172. At 50% reduction, the concentration of Ca⁺⁺ in the permeate is less than half of that in the feed and the Mg⁺⁺ is reduced by a factor of about 10.

### System Design

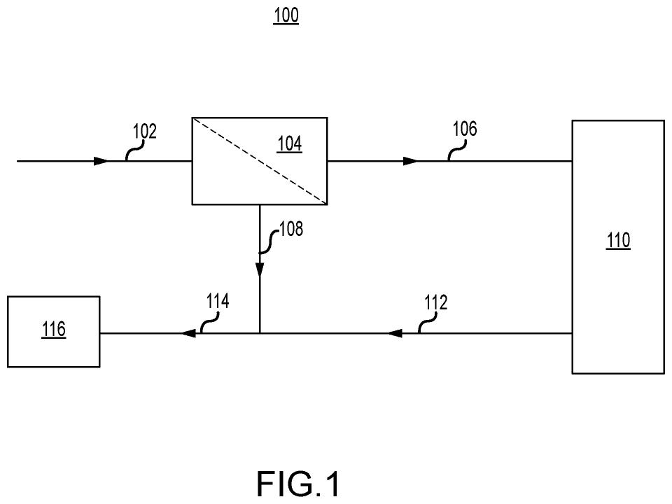

An example diagram of the system 100 and process is shown in FIG. 1. Lithium containing produced water 102 may be fed to one or more nanofiltration membrane elements 104 (e.g., a plurality of nanofiltration membrane elements). As noted above, under high applied pressure, a brine flux through the one or more nanofiltration membrane elements 104 occurs. However, calcium and magnesium are substantially blocked from passing through the one or more nanofiltration membrane elements 104. Chloride may pass freely through the one or more nanofiltration membrane elements 104, but to maintain electrical neutrality the chloride carries monovalent cations across the membrane. Due to the high level of chloride ions passing through the one or more nanofiltration membrane elements 104, the concentration of lithium and other monovalent cations is higher on the permeate side than the feed side. Accordingly, only the divalent cation reduced permeate 106 of the one or more nanofiltration membrane elements 104 is fed to a lithium absorber 110 for direct lithium extraction. Thus, the portion of the lithium which remains in the divalent cation rich retentate 108 of the one or more nanofiltration membrane elements 104 is not captured. Lithium depleted output 112 from the lithium absorber 110 may be combined with the divalent cation rich retentate 108 from the one or more nanofiltration membrane elements 104. The cost of further extracting the lithium from the retentate is less likely to be economical. The combined 114 lithium depleted output 112 from the lithium absorber 110 and the divalent cation rich retentate 108 from the one or more nanofiltration membrane elements 104 can be transported for deep well injection 116.

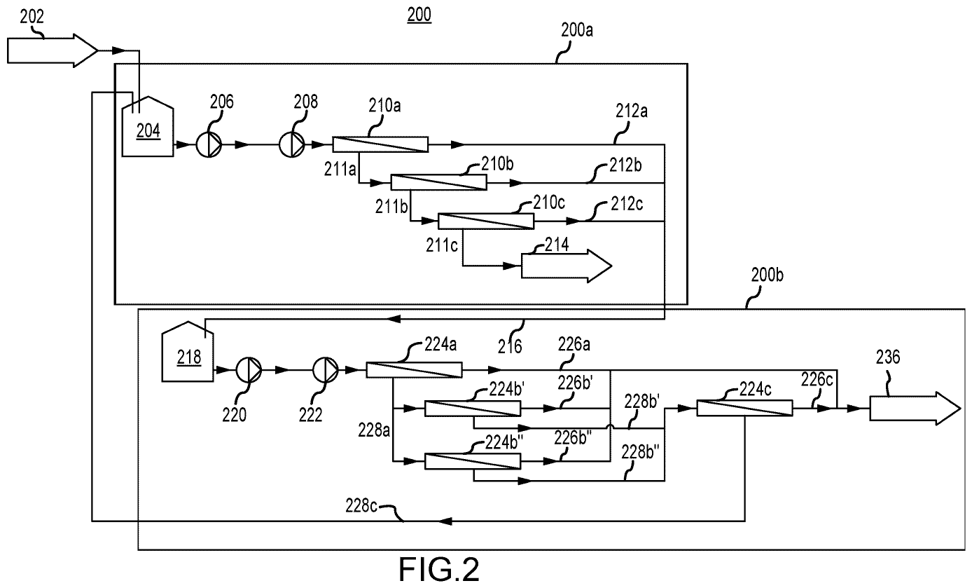

The system or process can also be extended to achieve greater reductions of divalent cations by introducing the permeate from a first pass of a nanofiltration process to one or more additional high-pressure nanofiltration systems. An example process flow diagram 200 of a pilot system having a first pass 200a and a second pass 200b of high-pressure nanofiltrations is shown in FIG. 2. In this embodiment, a pass is a group of membrane elements where the high pressure retentate sides are connected. The second pass 200b is the nanofiltration of the permeate from the first pass 200a. Each pass 200a, 200b has multiple stages, a stage being a housing containing multiple membrane elements. The retentate from each stage is connected to the next stage in series. Additional passes and/or stages may be employed. The systems and methods of the flow diagram 200 can also be used to enhance the capture of other valuable minerals such as rubidium or cesium from highly saline brines.

In some embodiments, a feed of lithium containing produced water 202 is fed to a container 204. In some embodiments, the lithium containing produced water 202 may be input to the container 204 at approximately 8 m³/hr. In a first pass 200a of a two-pass system or method, booster pump 206 and/or a high pressure pump 208 may direct the lithium containing produced water 202 to a first stage 210a of a plurality of nanofiltration membrane elements. Divalent cation rich retentate 211a from the first stage 210a may then be fed to a second stage 210b of the plurality of nanofiltration membrane elements. Divalent cation rich retentate 211b from the second stage 210b may then be fed to a third stage 210c of the plurality of nanofiltration membrane elements. Each of the first stage 210a, the second stage 210b, and the third stage 210c of the plurality of nanofiltration membrane elements may, for example, contain 6 membrane elements per housing and may consist of multiple housings. Divalent cation rich retentate 211c from the third stage 210c may then output as concentrate 214 at approximately 4 m³/hr for disposal such as deep well injection.

Divalent cation reduced permeate 212a, 212b, 212c from the first stage 210a, the second stage 210b, and the third stage 210c, respectively, may be combined 216 and fed to a container 218.

In a second pass 200b of the two-pass system, a booster pump 220 and/or a high pressure pump 222 may direct the combined permeate 216 to a first stage 224a of multiple nanofiltration membrane elements 224. Divalent cation rich retentate 228a from the first stage 224a may then be fed to two second stages 224b′, 224b″ of the multiple nanofiltration membrane elements 224. Divalent cation rich retentate 228b′, 228b″ from the two second stages 224b′, 224b″ may then be fed to a third stage 224c of the multiple nanofiltration membrane elements 224. Each of the first stage 224a, the two second stages 224b, and the third stage 224c of the multiple nanofiltration membrane elements 224 may, for example, contain 4 membrane elements per housing and may consist of multiple housings. Divalent cation rich retentate 228c from the third stage 224c may then be fed as concentrate to a container 204.

Divalent cation reduced permeate 226a, 226b′, 226b″, 226c from the first stage 224a, the two second stages 224b′, 224b″, and the third stage 224c, respectively, may be combined and fed as combined permeate 236 at approximately 4 m³/hr for input to a direct lithium extractor (not shown in this figure).

In an embodiment, a method for processing a highly saline brine containing monovalent and multivalent ions is disclosed. The method includes feeding the saline brine into a nanofiltration membrane at a high pressure effective to produce a permeate having (1) a concentration of multivalent cations that is lower than in the saline brine and (2) a concentration of monovalent cations that is higher than in the saline brine. In some embodiments of the method, one of the ions concentrated in the permeate is lithium. In some embodiments of the method, the lithium containing permeate is introduced to a direct lithium extraction process. In some embodiments of the method, ruthenium or cesium is concentrated in the permeate stream. The method may further comprise feeding the permeate to a second pass of high-pressure nanofiltration to further reduce the concentration of multivalent cations in the permeate.

In an embodiment, a system for concentrating monovalent cations is disclosed. The system may include a high-pressure nanofiltration device that operates at pressures above about 50 bar, a high salinity input brine stream containing monovalent cations, high levels of multivalent cations, and high levels of monovalent anions, a high-pressure source of about 50 bar or higher (such as about 60 bar or higher) applied to the input brine, and a permeate brine stream. In some embodiments, the total osmotic pressure of the high salinity input brine stream is above about 100 bar (such as above about 200 bar), the osmotic pressure of magnesium chloride and calcium chloride together is above about 60 bar, and monovalent anions account for about 90% or more of the total anions. Monovalent anions in the pressurized input brine stream may pass through the nanofiltration membrane, and monovalent anions passing through the filter may pull monovalent cations through the nanofiltration membrane to maintain electrical neutrality. Monovalent cations concentrate in the permeate brine stream to a higher level than the monovalent cation concentration in the input brine stream. In some embodiments, one of the monovalent cations concentrated in the permeate is lithium. Ruthenium and/or cesium may also be concentrated. In some embodiments, the monovalent anions are primarily chloride ions. In some embodiments, the multivalent cations include magnesium and/or calcium.

In another embodiment, a high-pressure nanofiltration device is disclosed. The high-pressure nanofiltration device is configured to receive an input of a brine solution under an applied pressure of about 50 bar and above (such as about 60 bar and above) and produce a higher concentration of monovalent cations on a permeate side of the nanofiltration device compared to the brine solution on a feed side of the nanofiltration device when the input of the brine solution includes a high salinity brine having a high level of divalent cations and a high level of monovalent anions where the total osmotic pressure of the high salinity brine is above about 100 bar (such as above about 200 bar), the osmotic pressure of magnesium chloride and calcium chloride together is above about 60 bar, and monovalent anions account for about 90% or more of the total anions. One of the monovalent cations concentrated in the permeate may be lithium. Ruthenium and/or cesium may also be concentrated. The monovalent anions may be primarily chloride ions. The multivalent cations may include magnesium and/or calcium.

In another embodiment, a lithium concentration system is disclosed. The lithium concentration system may include a high-pressure nanofiltration system and a high salinity brine feed stream containing lithium and high concentrations of multivalent cations, such as calcium and/or magnesium ions where the total osmotic pressure of the high salinity brine is above about 100 bar (such as above about 200 bar), the osmotic pressure of magnesium chloride and calcium chloride together is above about 60 bar, and monovalent anions account for about 90% or more of the total anions. Under a high feed stream pressure of about 50 bar or above (such as about 60 bar or above), the lithium concentration system may simultaneously or nearly simultaneously increase lithium concentration and reduce magnesium concentration of the brine feed stream. The permeate containing lithium may be passed through a direct lithium extractor to sequester the lithium from the permeate stream.

As used herein, the term “about,” “approximately,” or “substantially” refers to an allowable variance of the term modified by “about” by ±10% or ±5%. Further, the terms “less than,” “or less,” “greater than”, “more than,” or “or more” include as an endpoint, the value that is modified by the terms “less than,” “or less,” “greater than,” “more than,” or “or more.”

While various aspects and embodiments have been disclosed herein, other aspects and embodiments are contemplated. The various aspects and embodiment disclosed herein are for purposes of illustration and are not intended to be limiting. Features from any of the disclosed embodiments may be used in combination with one another, without limitation. In addition, other features and advantages of the present disclosure will become apparent to those of ordinary skill in the art through consideration of the following detailed description and the accompanying drawings.

1. A method for processing a highly saline brine input containing monovalent and multivalent ions, the method comprising:
feeding the highly saline brine input into a first pass of a nanofiltration membrane at a high pressure effective to produce a permeate having (1) a concentration of multivalent cations that is lower than the highly saline brine input and (2) a concentration of monovalent cations that is higher than the highly saline brine input, the nanofiltration membrane having a permeate brine stream and a retentate brine stream,
wherein feeding the highly saline brine input into the first pass of the nanofiltration membrane includes:
passing monovalent anions in the highly saline input brine stream through the nanofiltration membrane into the permeate;
pulling monovalent cations in the highly saline input brine stream through the nanofiltration membrane in response to monovalent anions passing through the nanofiltration membrane to maintain electrical neutrality, thereby concentrating monovalent cations in the permeate; and
concentrating multivalent cations in the retentate brine stream.

2. The method of claim 1, where one of the ions concentrated in the permeate is lithium.

3. The method of claim 2, where the lithium containing permeate is introduced to a direct lithium extraction process.

4. The method of claim 1, where ruthenium or cesium is concentrated in the permeate stream.

5. The method of claim 1, further comprising feeding the permeate to a second pass of high-pressure nanofiltration to further reduce the concentration of multivalent cations in the permeate.

6. A membrane system for softening brines while concentrating monovalent cations, the system comprising:
a) a high-pressure nanofiltration device that operates at pressures above nominal 40 bar standard nanofiltration pressure;
b) a high salinity input brine stream containing monovalent cations, high levels of multivalent cations, and high levels of monovalent anions, where a total osmotic pressure of the high salinity input brine stream is above about 100 bar, an osmotic pressure of magnesium chloride and calcium chloride together is above about 60 bar, and monovalent anions account for about 90% or more of the total anions;
c) a high-pressure source above about 50 bar applied to the input brine; and
d) a permeate brine stream;
wherein:
monovalent anions in the pressurized input brine stream pass through the nanofiltration membrane,
monovalent anions passing through the filter pull monovalent cations through the nanofiltration membrane to maintain electrical neutrality,
monovalent cations concentrate in the permeate brine stream to a higher level than the monovalent cation concentration in the input brine stream, and
multivalent cations are substantially blocked from entering the permeate.

7. The membrane system of claim 6, wherein one of the monovalent cations concentrated in the permeate is lithium.

8. The membrane system of claim 6, wherein one of the monovalent cations is ruthenium or cesium.

9. The membrane system of claim 6, wherein the monovalent anions are primarily chloride ions.

10. The membrane system of claim 6, wherein the multivalent cations includes magnesium and/or calcium.

11. A high-pressure nanofiltration device configured to receive an input of a brine solution under an applied pressure of above about 50 bar and that produces a higher concentration of monovalent cations on a permeate side of the nanofiltration device compared to the brine solution on a feed side of the nanofiltration device when the input of the brine solution includes a high salinity brine having a high level of divalent cations including at least one of magnesium chloride and/or calcium chloride, and a high level of monovalent anions where a total osmotic pressure of the high salinity brine is above about 100 bar, an osmotic pressure of magnesium chloride and calcium chloride together is above about 60 bar, and monovalent anions account for about 90% or more of the total anions of the high salinity brine, wherein, when the high salinity brine is passed through the nanofiltration device, monovalent anions in the high salinity brine pass through the nanofiltration device and pull monovalent cations through the nanofiltration device to the permeate side of the nanofiltration device to maintain electrical neutrality, thereby concentrating monovalent cations on the permeate side of the nanofiltration device, and wherein divalent cations in the high salinity brine are inhibited from passing through the nanofiltration device, leading to lower concentrations of divalent cations in the permeate.

12. The high-pressure nanofiltration device of claim 11, wherein one of the monovalent cations concentrated in the permeate is lithium.

13. The high-pressure nanofiltration device of claim 11, wherein the monovalent anions are primarily chloride ions.

14. The high-pressure nanofiltration device of claim 11, wherein the multivalent cations includes magnesium and/or calcium.

15. A lithium concentration system, comprising:
a high-pressure nanofiltration system having at least one nanofiltration membrane at a pressure of at least about 50 bar;
a high salinity brine feed stream containing lithium and high concentrations of multivalent cations, such as calcium and/or magnesium ions, where a total osmotic pressure of the high salinity brine feed stream is above about 100 bar, an osmotic pressure of magnesium chloride and calcium chloride together is above about 60 bar, and monovalent anions account for about 90% or more of the total anions in the high salinity brine feed stream; and
a permeate brine stream,
wherein the lithium concentration system simultaneously or nearly simultaneously increases lithium concentration and reduces magnesium and/or calcium concentration of the permeate compared to that of the high salinity brine feed stream, wherein monovalent anions in the high salinity brine stream pass through the at least one nanofiltration membrane and pull lithium cations through the at least one nanofiltration membrane and into the permeate brine stream to maintain electrical neutrality, thereby concentrating lithium cations in the permeate brine stream while the magnesium and/or calcium ion do not readily pass through the nanofiltration membrane into the permeate brine stream.

16. The system of claim 15, wherein the permeate containing lithium is passed through a direct lithium extractor to sequester the lithium from the permeate stream.

17-27. (canceled)
